(19) United States
(12) Patent Application Publication
(10) Pub. No.: US 2014/0077014 A1
(43) Pub. Date: Mar. 20, 2014

(54) System and Method for Hay Bale Conversion

(71) Applicant: Al Cooper, Waynesboro, GA (US)

(72) Inventor: Al Cooper, Waynesboro, GA (US)

(21) Appl. No.: 13/616,795

(22) Filed: Sep. 14, 2012

(51) Int. Cl. A23N 17/00; B02C 23/02; B02C 19/00

(52) U.S. Cl. 241/165.5; 241/277

(57) ABSTRACT

The presently disclosed embodiments, as well as features and aspects thereof, are directed toward a hay bale conversion system. An exemplary embodiment includes a prep table, a converter table and a feed table. The prep table queues hay bales and deposits them into a first position on the converter table. A push blade assembly is hydraulically advanced such that a hay bale that was deposited in the first position, whether the hay bale is round or square in form, will be moved to a second position at the opposite end of the converter table and thrashed down into an un-baled form by a thrasher assembly. The un-baled hay is then deposited onto a first end of a feed table and advanced along the feed table to baling machine that is operationally connected such that the un-baled hay is received and reformed into a bale of a desirable size and/or weight.

### BACKGROUND

Hay production and harvest is a multi-step farming process that includes cutting, drying, processing, and storing. Though the steps are essentially the same, the equipment available to modern day farmers for completing each “haymaking” step is far advanced over that which was used by their farming predecessors. Regardless of the equipment that is used (or not used), hay making requires cutting tall grass and legumes at the proper stage of maturity, allowing the cut grass to dry, and raking the dried grass into long, narrow piles known as windrows. Once in windrows, the grass or hay is gathered and processed into bales before being placed in storage, such as a barn or shed, to protect it from moisture and rot.

Each of the steps in haymaking can be done essentially by hand, i.e. a very hardworking man armed with a sickle blade, a pitch fork and a strong back. Most farmers today, however, prefer to take advantage of modern farming equipment and implements. For instance, a tractor pulling a mower or mower-conditioner (a mower designed to crimp and split the grass stalks so that moisture can escape) can be used to cut the hay before a second pass is made with a hay rake that rakes the cut hay into windrows. Alternatively, a single pass with a tractor pulling a swather can cut the hay and fold it up into windrows at the same time. Once in windrows, the hay endures a drying period during which the windrows may be turned over to speed the drying process or spread out and fluffed up with an implement known as a tedder.

Once hay is cut, dried and raked into windrows, it is processed into bales before being retrieved and transported to a storage location. Balers are usually pulled down a windrow by a tractor. The hay is gathered by the baler and then processed into bales which are deposited right there in the field to be retrieved at a later time. Some balers produce rectangular bales small enough for a person to lift, usually weighing between 70 and 100 pounds each. However, to take advantage of the economy of scale, many farmers today use balers capable of producing large bales that weigh up to 3,000 pounds. The large bales, depending on the particular baler used to produce them, may be of a “round” type (i.e., cylindrical) with a 4′ to 6′ diameter or of a “square” type (i.e., rectangular) having dimensions upwards of 8′×8′×10′.

Hobby farmers and people who own small numbers of livestock, particularly horses, prefer the small bales that can be handled by one person without machinery. Also, because bales that become moldy or contaminated must be discarded, small bales are desirable for many consumers who can't risk the cost of having to discard a larger bale. For these reasons, and others, there exists a strong market for the smaller bales. Even so, many farmers who produce hay with the intent to sell it, prefer the cost effectiveness that goes along with haymaking in large bale sizes.

Therefore, there is a need in the art for a system and method of converting large round and/or large square hay bales into small square bales.

### BRIEF SUMMARY

The presently disclosed embodiments, as well as features and aspects thereof, are directed toward a hay bale conversion system. An exemplary embodiment includes a prep table, a converter table and a feed table. The prep table is operable to receive one or more hay bales, round or square in shape, into a queue for conversion into a different form. The queued bales are advanced through the queue on the prep table and deposited, one by one, into a first position on the converter table. Alternatively, in some embodiments, a hay bale may be placed directed onto the converter table.

A push blade assembly that includes a bulldozer-like blade is hydraulically advanced along the length of the converter table such that a hay bale that was deposited in the first position will be slid or otherwise moved to a second position at the opposite end of the converter table. Once in the second position, the hay bale is in physical contact with a thrasher assembly that includes rotating spikes. The rotating spikes thusly thrash the hay bale down into an un-baled form, i.e. loose hay or relatively small clumps of hay or relatively small flakes of hay.

The un-baled hay is then deposited onto a first end of a feed table and advanced along the feed table to a second end. In some embodiments, at a point along the feed table between the first end and second end, a secondary thrasher assembly may be operable to further thrash the un-baled hay into a more refined form. At the second end of the feed table, a typical baling machine is operationally connected such that the un-baled hay is received and reformed into a bale of a desirable size and/or weight.

### BRIEF DESCRIPTION OF THE SEVERAL VIEWS OF THE DRAWING

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is an elevation view of an exemplary hay bale converter system;

FIG. 2 is a top view of the exemplary hay bale converter system depicted in FIG. 1;

FIG. 3 is a detailed perspective view of a table drive subsystem included in the prep table and feed table of the exemplary hay bale converter system of FIG. 1;

FIG. 4 is a detailed perspective view of a push blade subsystem included in the converter table of the exemplary hay bale converter system of FIG. 1;

FIGS. 5-7 are detailed perspective views of aspects of the push blade subsystem depicted in FIG. 4; and

FIG. 8 is a detailed perspective view of a primary thrasher subsystem included in the converter table of the exemplary hay bale converter system of FIG. 1.

### DETAILED DESCRIPTION

Aspects, features and advantages of several exemplary embodiments of a hay bale conversion system will become better understood with regard to the following description in connection with the accompanying drawing(s). It should be apparent to those skilled in the art that the described embodiments of the present hay bale conversion system provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute terms such as, for example, “will,” “will not,” “shall,” “shall not,” “must” and “must not” are not meant to limit the scope of a hay bale conversion system as the embodiments disclosed herein are merely exemplary.

The word “exemplary” is used herein to mean “serving as an example, instance, or illustration.” Any aspect described herein as “exemplary” is not necessarily to be construed as exclusive, preferred or advantageous over other aspects.

The term “control,” unless otherwise indicated, is used herein to refer to those subsystems, components, devices, software, ladder logic code, etc. that contribute to the actuation and/or automation of a particular hay bale converter embodiment. For this reason, one of ordinary skill in the art will recognize that terms such as “control station,” “control line,” “control signal,” and the like envision any and all control schemes and/or systems known in the art to be suitable for automation of discrete processes and equipment. For instance, although exemplary embodiments of a hay bale converter are described below in the context of a hydraulic based control system that includes hydraulic motors, hydraulic control lines, a hydraulic valve bank and the like for use by a user to control various functionalities of a hay bale converter, it is envisioned that more automated and advanced control schemes using programmable logic controllers, PID controllers, electric actuators, pneumatic actuators, etc. may be used by some embodiments.

The presently disclosed embodiments, as well as features and aspects thereof, are directed towards providing a system and method for converting large round or square hay bales into small hay bales. Advantageously, embodiments of a hay bale conversion system may receive large round bales and/or large square bales and convert them into small square bales that are manageable by a person. In this way, embodiments of a hay bale conversion system enable a user who desires small bales to benefit from the typically lower cost per weight associated with the purchase of large hay bales.

An exemplary embodiment comprises a series of three conveying tables: a prep table, a converter table and a feed table. Each of the tables, as well as various other components, assemblies or subsystems within the exemplary embodiment, may be operationally controlled by a central control station. The prep table may essentially include a conveyer belt configured to receive one or more large hay bales in a queue for processing. The prep table, operating according to control signals received from the central control station, may advance large hay bales, one by one, out of the queue and onto an adjacent converter table.

Once on the converter table, an exemplary embodiment may leverage a push blade or ram assembly to slide the large hay bale towards a thrasher assembly. The thrasher assembly, which in some embodiments may comprise a rotating drum with a series of radially extended spikes, systematically breaks the large hay bale back down into un-baled hay. Notably, it is envisioned that a given thrasher assembly may convert a large hay bale into un-baled hay that includes loose hay, clumps of compacted hay or a combination thereof and, as such, the particular condition of the un-baled hay produced as a result of a large hay bale being converted by a thrasher assembly of a given embodiment will not limit the scope of a hay bale conversion system.

Returning to the exemplary embodiment, the un-baled hay is subsequently received by the feed table. The feed table, similar to the prep table, may include a conveyor belt system operationally connected to a small square baling machine. The un-baled hay, having been deposited on the feed table from the converter table via the thrasher assembly, is delivered to a square baling machine that re-bales the hay into small square bales.

Notably, exemplary embodiments of a hay bale conversion system are described herein in the context of converting large round and/or square bales into small square bales. However, it is envisioned that certain embodiments of a hay bale conversion system that fall within the scope of this disclosure will be suited for conversion of any given bale type into a different bale type and, as such, a hay bale conversion system will not be limited to a system intended for converting large round and/or square bales into small square bales. For instance, certain embodiments may be configured to receive any given bale type of any given size, convert the received bale into un-baled hay and then re-bale the hay according to the capabilities of an operationally connected baling machine. As such, it is envisioned that embodiments of a hay bale conversion system that fall within the scope of this disclosure may, for example, receive large round bales and convert them to large square bales or vice versa.

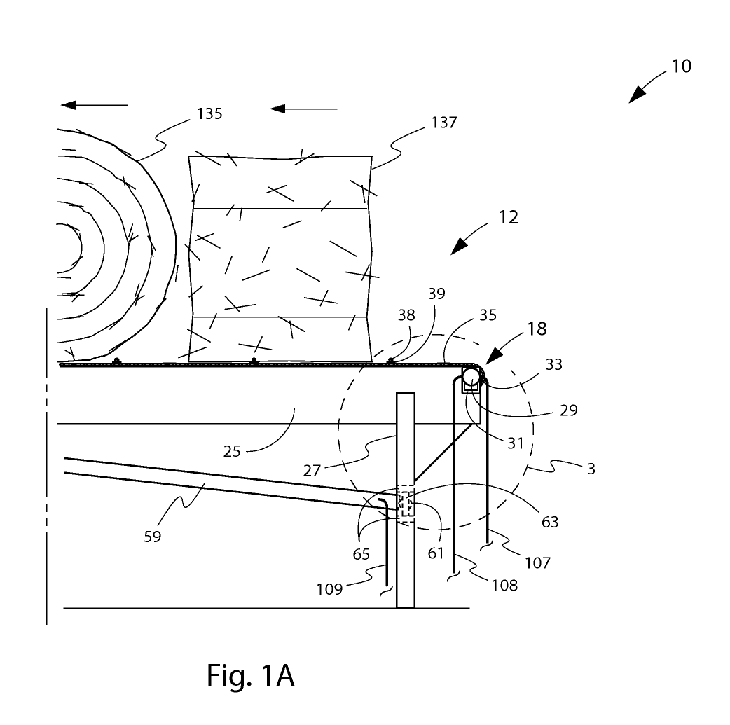

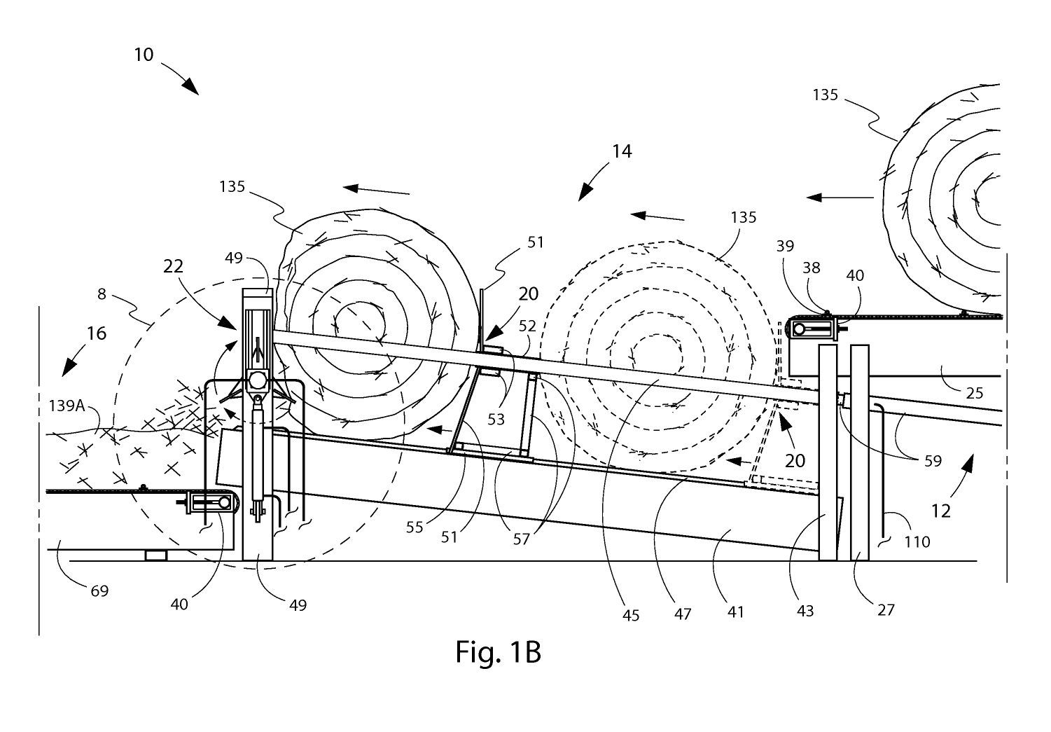

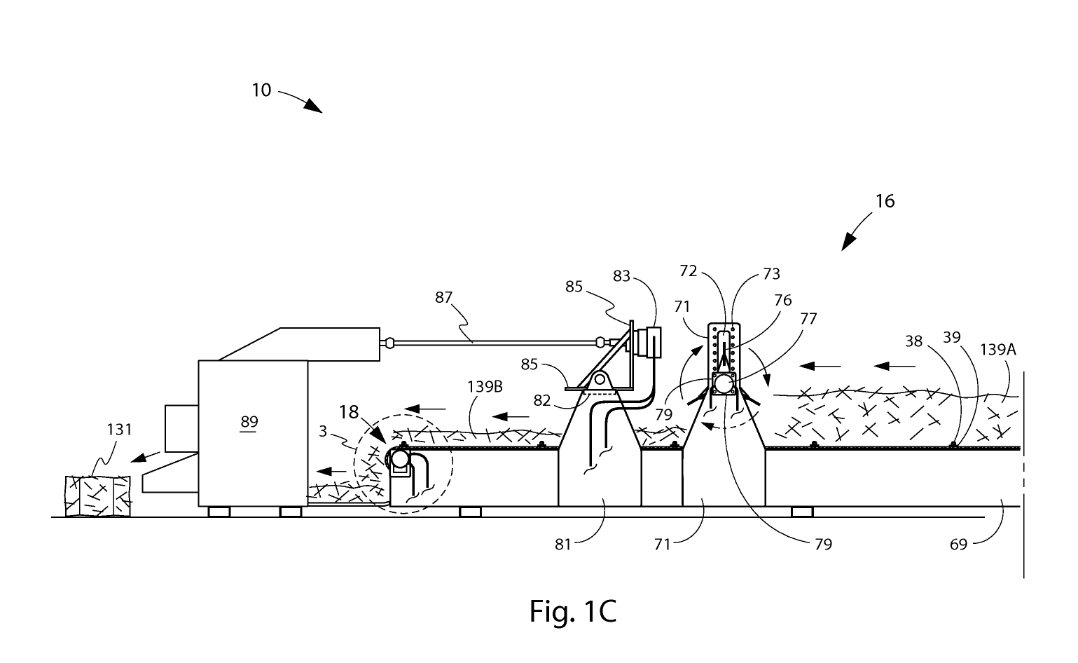

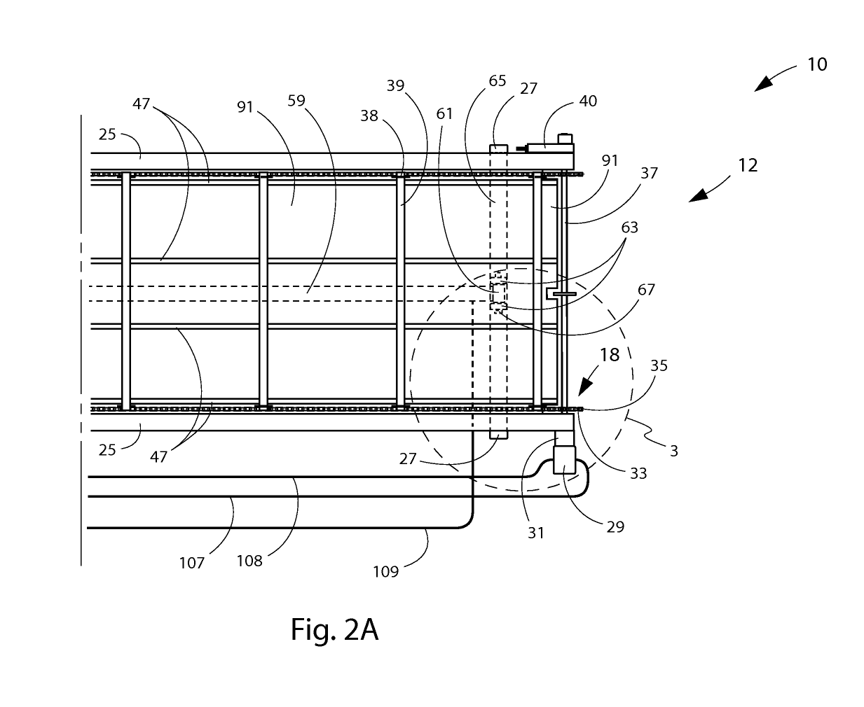

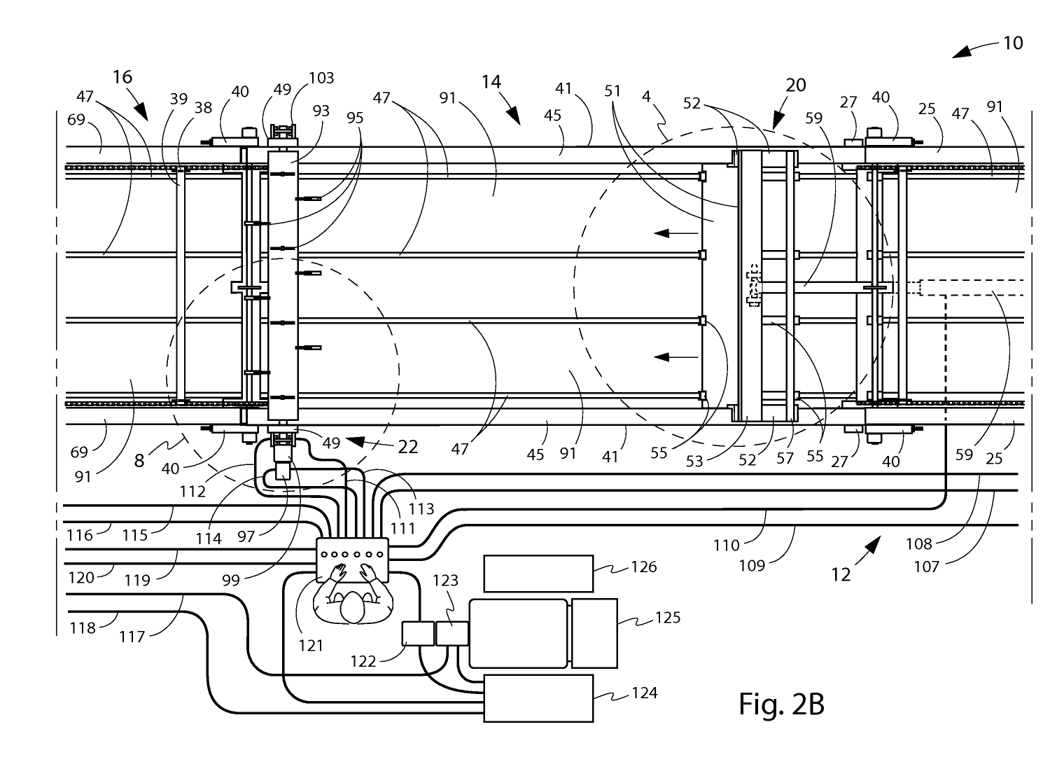

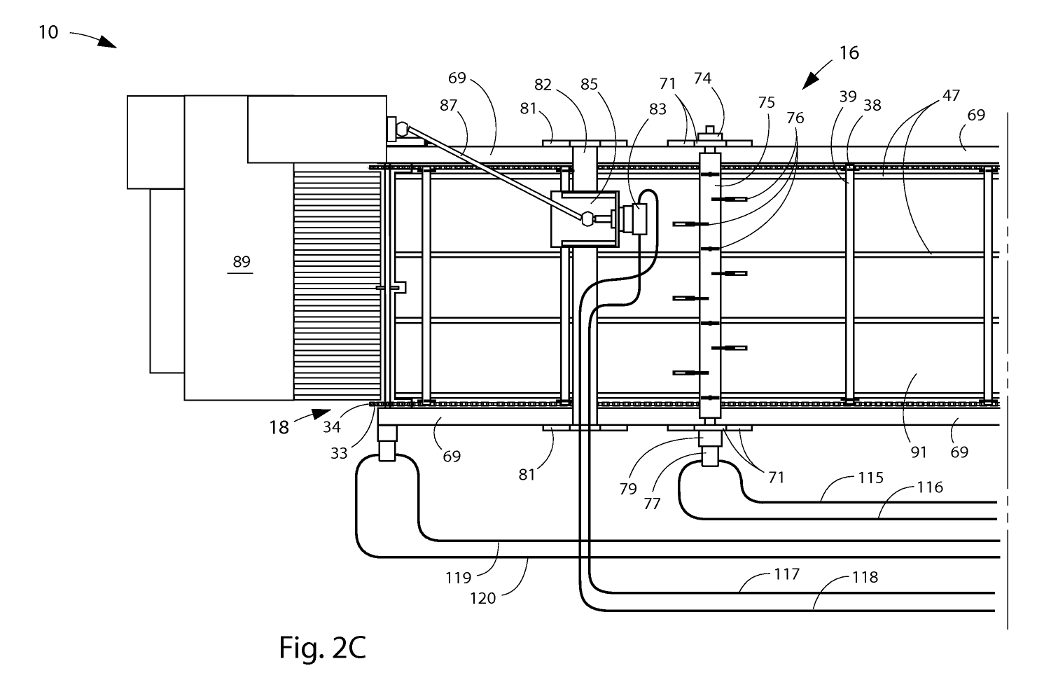

FIGS. 1A-1C depict an elevation view of an exemplary hay bale conversion system 10, with FIG. 1A depicting a front half of a prep table 12; FIG. 1B depicting the back half of the prep table 12, a converter table 14 and the front half of a feed table 16; and FIG. 1C depicting the back half of the feed table 16 and a baling machine 89. FIGS. 2A-2C depict a top view of the exemplary hay bale conversion system illustrated in FIG. 1, with FIG. 2A depicting the front half of the prep table 12; FIG. 2B depicting the back half of the prep table 12, the converter table 14 and the front half of the feed table 16; and FIG. 2C depicting the back half of the feed table 16 and the baling machine 89.

Describing the FIG. 1 and FIG. 2 drawings together, beginning with FIGS. 1A and 2A and advancing through to FIGS. 1B and 2B and then 1C and 2C, a large round bale 135 and a large square bale 137 reside in a queue on prep table 12. As described above, it is an advantage of certain embodiments of a hay bale conversion system 10 that large round bales and/or large square bales can be accommodated for eventual conversion to smaller bales.

The exemplary prep table 12 is depicted to include a series of leg members 27 for positioning a support frame 25 at a given height. At an end of the support frame 25 is a drive assembly 18 for actuating a conveyor assembly that includes a series of cross bars 39 that each mechanically engage 38 on each side to a pair of parallel drive chains 35. Drive chains 35 extend the length of prep table 12 and are each fixed around a pair of complimentary front and back sprockets 33 mounted at either end, and on the same side, of prep table 12. The front sprockets 33 are connected to each other via a shaft 37. Similarly, the rear sprockets 33 are connected to each other via a different shaft 37. The front sprockets 33 are turned by a mechanically engaged motor 29 and coupling 31, which in turn causes the parallel drive chains 35 to rotate around their respective sprocket pairs thereby causing the series of cross bars 39 to advance along the prep table 12, as would be understood by one of ordinary skill in the art.

In the exemplary embodiment 10, the motor 29 is a hydraulic motor powered by a pair of hydraulic control lines 107, 108 routed through a control valve, as would be understood by one of ordinary skill in the art. Notably, however, although the present embodiment is being described within the context of a solenoid valve control bank 121 operationally controlling hydraulic drive components, it is envisioned that other embodiments may include, but are not limited to, electronic control systems, pneumatic control systems, hydraulic control systems, or combinations thereof. Moreover, it is envisioned that certain embodiments may use pneumatic and/or electronic control signals to operationally control components within a hay bale conversion system that are hydraulically, electrically and/or pneumatically driven. As a non-limiting example, certain embodiments may use a programmable logic controller (“PLC”), such as an Allen Bradley “Slick 50” or the like, to leverage sensor signals, user inputs and 4-20 mA or 0-10V control signals to drive electric motors powered on 120Vac or pneumatic actuators powered by a 60-100 psi compressed air source. Additionally, it is envisioned that some embodiments may leverage chains, belts, gears or the like to advance hay bales and/or un-baled hay through a given hay bale conversion system.

Returning to the FIGS. 1 and 2, tensioners 40 may be used to keep drive chains 35 at a proper tension. Also, a floor plate 91 with a series of spine elements 47 for added structural rigidity may be positioned on support frame 25 beneath cross bars 39 in order to “catch” loose hay or other debris originating from queued bales 135, 137.

As the cross bars 39 are advanced along prep table 12, the queued bales 135, 137 are advanced toward operationally connected converter table 14. Notably, although the exemplary embodiment being described leverages cross bars 39 in mechanical communication 38 with drive assembly 18 to advance queued bales 135, 137 toward converter table 14, it is envisioned that other means for advancing the bales along prep table 12 including, but not limited to, a conveyor belt with a relatively high static coefficient of friction may be used in other embodiments.

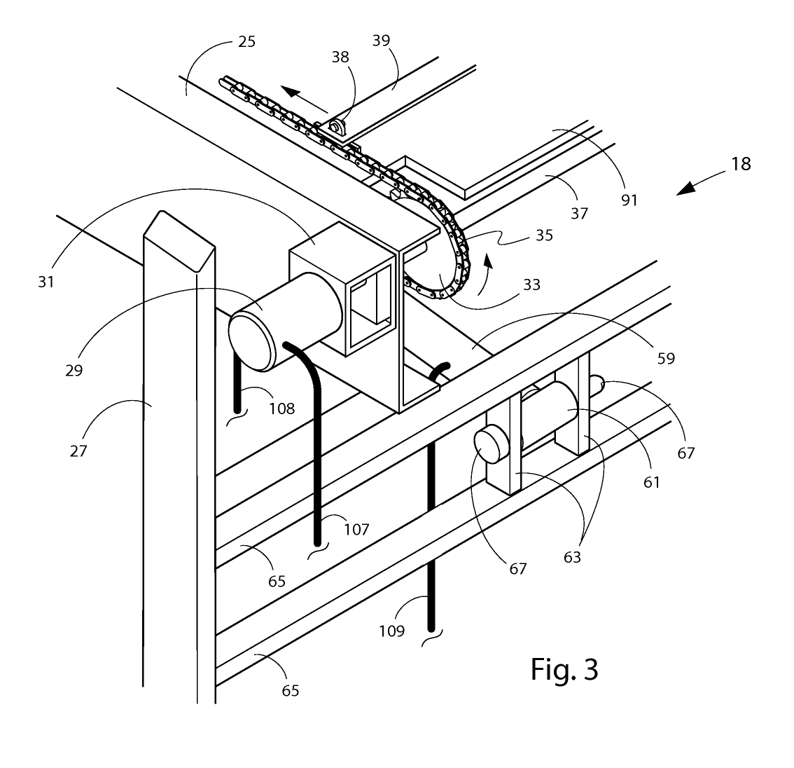

Briefly turning to FIG. 3, a detail view of the table drive subsystem 3 is depicted. Beneath the support frame 25 of prep table 12, a hydraulic cylinder 59 is depicted as being anchored at an anchor point created by horizontal cross beams 65 in cooperation with vertical cripples 63. The cross beams 65 extend between legs 27 on the front end of the prep table 12. As can be best seen in FIG. 3, a tube-like component 61 at the butt end of the hydraulic cylinder 59 is rotationally fixed in a set position between cripples 63 by a pin 67 that extends through the tube-like component 61 and the cripples 63. As one of ordinary skill in the art would recognize from such an arrangement, the hydraulic cylinder 59 may be rotated in an arc around the anchor point.

Returning to FIGS. 1 and 2, hydraulic control lines 109 and 110 running from control station 121 operationally control the extension and retraction of hydraulic cylinder 59, as would be understood by one of ordinary skill in the art. As can be best seen in FIG. 1B, a bale 135 is carried forward by cross bars 39 of prep table 12 until the bale 135 is deposited off the back end of prep table 12 and received at the front end of converter table 14. At the time bale 135 is received onto converter table 14, hydraulic cylinder 59 is in a retracted position such that push blade assembly 20 is behind bale 135. Subsequently, control station 121 may cause pressure in hydraulic cylinder 59 to be relieved through control line 110 and applied through control line 109, thereby causing the hydraulic cylinder 59 to extend and drive push blade assembly 20 towards the far end of converter table 14. Notably, because bale 135 was deposited off of prep table 12 and onto converter table 14 in front of push blade assembly 20, the extension of hydraulic cylinder 59 leverages push blade assembly 20 to push bale 135 along converter table 14 toward the primary thrasher assembly 22 positioned at the far end of converter table 14. Further, in the exemplary embodiment, frame 41 of the converter table 14 is inclined such that the position of bale 135 along converter table 14 can be controlled by the relative position of push blade assembly 20. Similar to prep table 12, converter table 14 may be supported by leg members 43 and 49.

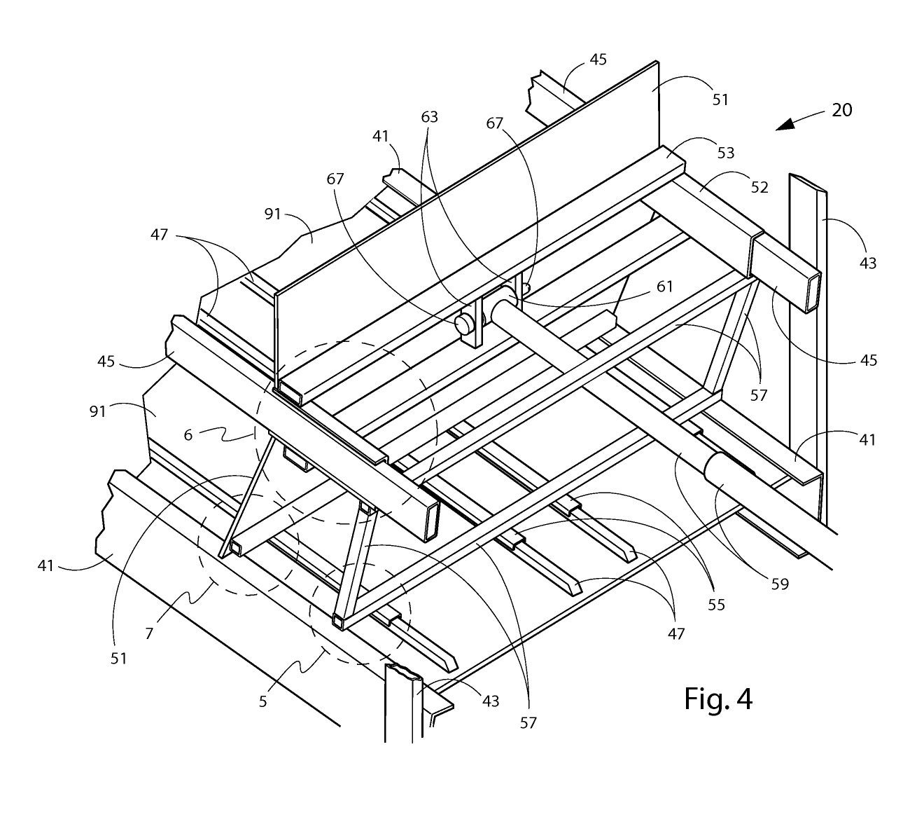

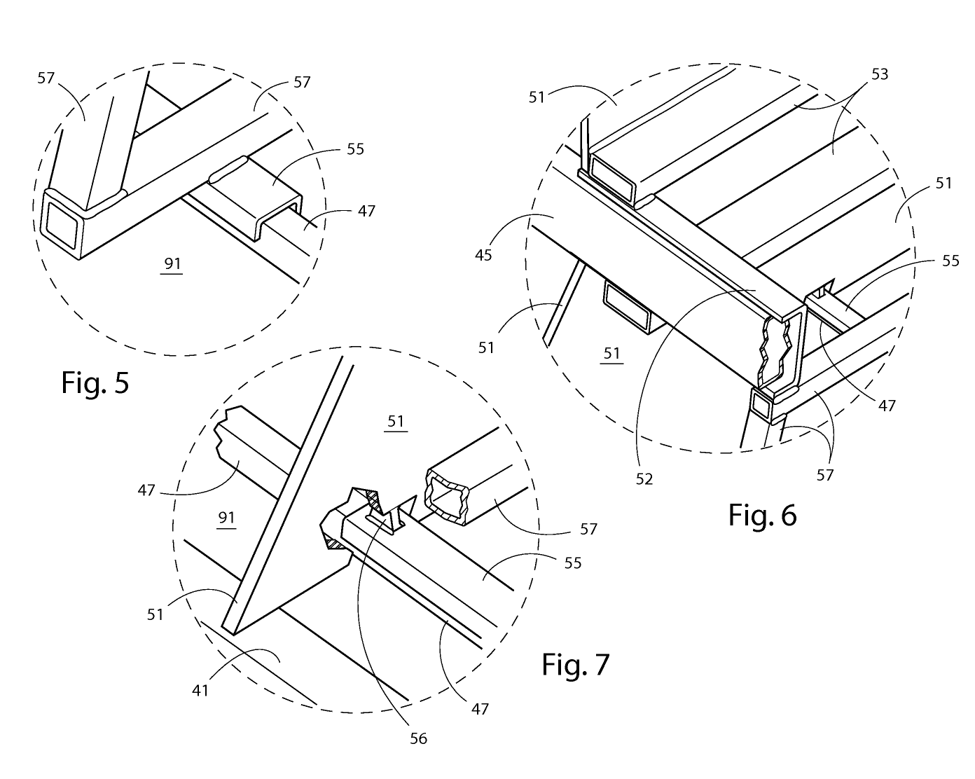

Turning briefly to FIGS. 4-7, a detailed view of the push blade subsystem 4 in FIG. 4 includes detailed views 5-7 depicted in FIGS. 5-7. As can be seen in the FIG. 4 illustration, the hydraulic cylinder 59 is rotationally anchored to the backside of the push blade 51 in much the same manner as it is rotationally anchored beneath the prep table 12. An anchor point is created behind push blade 51 by cross beams 53 working in cooperation with cripples 63. A tube-like component 61 at the end of the hydraulic cylinder 59 is rotationally anchored at the anchor point via a pin 67. Notably, because the hydraulic cylinder 59 is rotationally anchored at the respective anchor points, the hydraulic cylinder 59 may translate up and down as the push blade assembly 20 is extended and retracted along the inclined convert table 14.

The push blade assembly 20, in addition to the push blade 51, includes a positioning structure comprised of frame members 57, upper slide channels 52 and lower slide channels 55. The upper slide channels 52 are communicatively coupled to side rails 45 which extend the length of converter table 14 at a height roughly midway to the height of push blade 51. The lower slide channels 55 are communicatively coupled to floor rails 47 which are fixed on a floor component 91 positioned beneath the push blade assembly 20. Consequently, as the push blade assembly 20 is translated along the converter table 14, the upper and lower slide channels 52, 55 slide on side rails 45 and floor rails 47, respectively, to guide the push blade assembly 20 along the converter table.

Returning to FIGS. 1B and 2B, as the push blade assembly 20 is guided along the converter table 14 toward the feed table 16, the hay bale 135 is forced into contact with the primary thrasher assembly 22. The primary thrasher assembly 22 is positioned at the elevated end of the converter table 14 which is operationally connected to the front end of the feed table 16. Notably, it is an advantage of the hay bale conversion system 10 that any shape of hay bale can be accommodated. Because the push blade assembly 20 pushes the bale 135 along the converter table 14 and into contact with the primary thrasher assembly 22, as opposed to rolling the bale or unfurling the bale, one of ordinary skill in the art will recognize that a large square bale 137 can be also be accommodated.

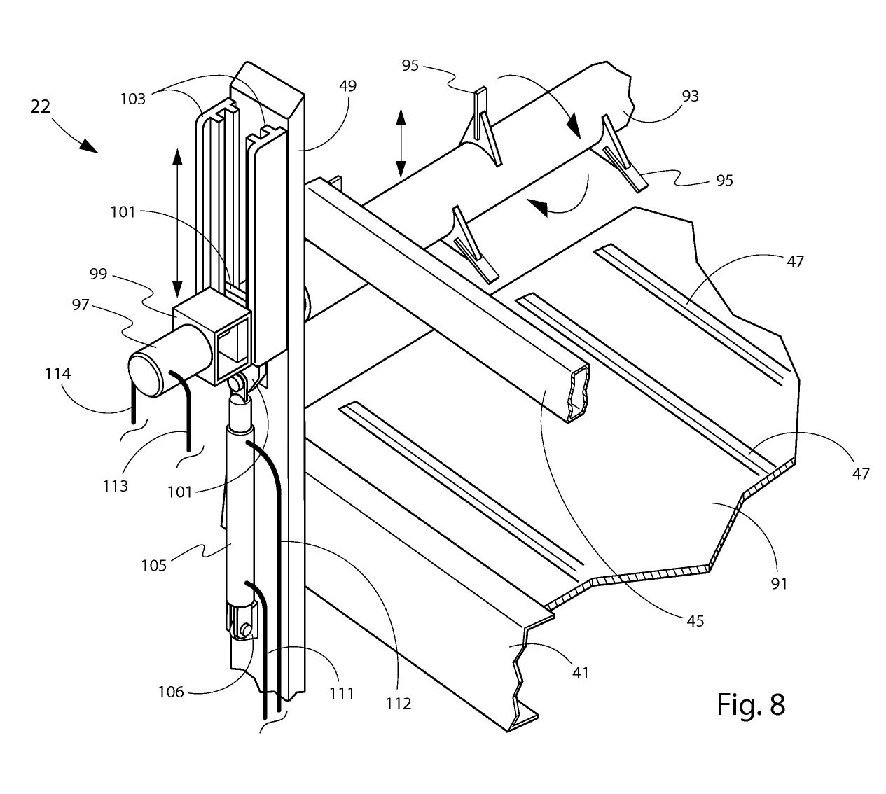

Briefly turning to FIG. 8, a detail view of the primary thrasher subsystem 8, which includes the primary thrasher assembly 22, is depicted. The primary thrasher assembly 22 includes a rotating drum 93 equipped with a series of spikes 95. The rotating drum 93 is communicatively coupled to a drive assembly that includes a motor 97, a coupling component 99 and a guide plate 101. Similar to that which has been described above, a pair of control lines 113, 114 in communication with the main control station 121 serve to power and control the motor 97, which in turn powers the rotation of the primary thrasher assembly 22. The guide plate 101 is communicatively coupled to a vertical guide rail 103 which is mounted to a vertical support leg 49 that also provides support to the overall converter table 14.

As one of ordinary skill in the art would recognize, the rotating primary thrasher assembly 22 leverages the spikes 95 to thrash a bale 135, 137. Because the bale 135, 137 may be tall relative to the height setting of the primary thrasher assembly 22, the exemplary embodiment 10 includes a hydraulic cylinder 105 anchored 106 to the outside of leg 49 and mechanically coupled to the primary thrasher assembly 22 via guide plate 101. Actuation of the hydraulic cylinder 105 via control lines 111, 112 may cause the primary thrasher assembly 22 to raise or lower in position height as the guide plate 101 slides in the vertical guide rail 103. In this way, an operator at main control station 121 can manipulate the height of the primary thrasher assembly 22 in the vertical guide rail 103 such that the hay bale 135, 137 is efficiently converted to un-baled hay 139A.

On the downside of the primary thrasher assembly 22, the un-baled hay 139A is deposited onto feed table 16. Much like prep table 12, feed table 16 is equipped with a floor component 91 mounted within a structural frame 69. A series of cross bars 39 in mechanical communication 38 with a drive chain 34 that is actuated with a motor drive sprocket 33 arrangement are positioned over and across the floor component 91. The un-baled hay 139A coming from the primary thrasher assembly 22 is deposited on the floor component 91 and raked down the feed table 16 via the cross bars 39 as they are actuated by the drive chain. Notably, as mentioned above, it is envisioned that other means for carrying the un-baled hay 139A along the feed table 16 may be used by certain embodiments including, but not limited to, a conveyor belt, a sweeping mechanism, etc.

Turning to FIGS. 1C and 2C, the exemplary feed table 16 includes a secondary thrasher assembly adjustably 73 mounted in a vertical slot 72 of a support component 71. Similar to the primary thrasher assembly 22, the secondary thrasher assembly on feed table 16 may be positioned such that a rotating drum 75 equipped with spikes 76 may further thrash the un-baled hay 139A into a more desirable consistency of primarily loose hay 139B before it is fed into a baler 89. Notably, it is envisioned that the secondary thrasher assembly, if included in a given embodiment, may be automatically adjustable in height position (such as was described relative to primary thrasher assembly 22) or may be adjustable to predetermined, fixed positions (such as by positioning holes 73) or may be permanently fixed in position relative to the floor surface 91 of feed table 16. It is a further advantage of a secondary thrasher assembly that the thickness of the loose hay 139B sheet may be controlled to optimize the efficiency of baler 89 and minimize operational waste.

The baler 89 may be driven by a drive shaft 87 powered by a motor 83 mounted on feed table 16 via a support structure 81, 82, 85. As one of ordinary skill in the art would recognize, the drive shaft 87 of baler 89 may be operable to be driven by a power take-off (“PTO”) on a tractor or other piece of equipment. Accordingly, it is an advantage of a hay conversion system 10 that a “pull behind” baler may be operationally connected to the system 10 via a drive shaft 87 such that it can operate in a stationary position. Loose hay 139B or un-baled hay 139A may be received by the baler 89 as it exits the end of the feed table 16 and converted to a small bale 131 (or any bale 131 of a size and shape dictated by baler 89).

Returning to FIG. 2B, the control system of the hay bale conversion system 10 includes a main control station 121 for controlling signals and/or power inputs via control lines 107-120. The exemplary embodiment of a hay bale conversion system 10 has been depicted and described in the context of a hydraulic control system; however, it is envisioned that other embodiments of a hay bale conversion system 10 may leverage different control schemes or combinations of control schemes including, but not limited to, electric and pneumatic controls.

In the exemplary system 10, the control system is hydraulic. Main control station 121 includes a solenoid valve bank (not shown) that is configured to apply and relieve hydraulic pressure in lines 107-120, as would be understood by one of ordinary skill in the art. A hydraulic oil tank 124 is operationally connected to a baler pump 123 and a converter pump 122 which are driven by engine 125. Engine 125 may be an internal combustion engine powered by engine fuel 126 such as diesel or gasoline; however, electric motors or other suitable power sources are envisioned as alternatives to engine 125.

In the exemplary embodiment 10, control lines 107, 108 are operationally connected to the drive assembly 3 at the front end of prep table 12. Control lines 109, 110 are operationally connected to the hydraulic cylinder 59 which drives the push blade assembly 20. Control lines 111, 112 are operationally connected to the hydraulic cylinder 105 which vertically positions primary thrasher assembly 22. Control lines 113,114 are operationally connected to motor 97 which rotates the primary thrasher assembly 22. Control lines 115, 116 are operationally connected to the secondary thrasher assembly. Control lines 117, 118 are operationally connected to the motor 83 which powers the baler 89. Control lines 119, 120 are operationally connected to the drive assembly 18 of the feed table 16 which actuates the sprocket 33 and drive chain 34.

Systems, devices and methods for the hay bale converter have been described using detailed descriptions of embodiments thereof that are provided by way of example and are not intended to limit the scope of the disclosure. The described embodiments comprise different features, not all of which are required in all embodiments of a hay bale converter. Some embodiments of a hay bale converter utilize only some of the features or possible combinations of the features. Variations of embodiments of a hay bale converter that are described and embodiments of a hay bale converter comprising different combinations of features noted in the described embodiments will occur to persons of the art.

It will be appreciated by persons skilled in the art that systems, devices and methods for the provision of hay bale conversion is not limited by what has been particularly shown and described herein above. Rather, the scope of systems, devices and methods for the provision of hay bale conversion is defined by the claims that follow.

Further, certain steps in the processes or process flows described in this specification naturally precede others for an embodiment of a hay bale converter to function as described. However, a hay bale converter is not limited to operating according to the order of the steps described if such order or sequence does not alter the functionality of the hay bale converter. That is, it is recognized that some steps may performed before, after, or parallel (substantially simultaneously with) other steps without departing from the scope and spirit of a hay bale converter. In some instances, certain steps may be omitted or not performed without departing from the invention. Further, words such as “thereafter”, “then”, “next”, etc. are not intended to limit the order of the steps or functions. These words are simply used to guide the reader through the description of the exemplary method and/or exemplary functionality.

In one or more exemplary aspects, the functions of a hay bale converter described herein may be triggered by the use of hardware, software, firmware, or any combination thereof. If triggered by software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Therefore, disclosure of a particular set of program code instructions, ladder logic or detailed hardware devices is not considered necessary for an adequate understanding of how to make and use a hay bale converter. The inventive functionality of the claimed hay bale converter is explained in more detail in the above description and in conjunction with the drawings, which may illustrate various process flows.

What is claimed is:

1. A hay bale conversion system comprising:
a converter table operable to receive a hay bale;
a push blade assembly operable to move between a first position and a second position, such that a hay bale received on the converter table is moved by the push blade assembly from the first position to the second position; and
a primary thrasher assembly operable to thrash a hay bale into an un-baled form;
wherein when a hay bale is in the second position on the converter table, the hay bale is in contact with the primary thrasher assembly such that the primary thrasher assembly can thrash the hay bale into un-baled hay.

2. The hay bale conversion system of claim 1, wherein the push blade assembly is moved between the first and second positions by a hydraulic cylinder.

3. The hay bale conversion system of claim 1, wherein the converter table is inclined such that the first position is lower than the second position.

4. The hay bale conversion system of claim 1, wherein the primary thrasher assembly is operable to be raised and lowered while thrashing a hay bale.

5. The hay bale conversion system of claim 1, wherein the push blade assembly and the primary thrasher assembly are hydraulically controlled.

6. The hay bale conversion system of claim 1, wherein the push blade assembly and the primary thrasher assembly are pneumatically controlled.

7. The hay bale conversion system of claim 1, wherein the push blade assembly and the primary thrasher assembly are electronically controlled.

8. The hay bale conversion system of claim 1, further comprising a prep table operationally connected to the converter table, wherein a hay bale released from a queue on the prep table is deposited in the first position of the converter table.

9. The hay bale conversion system of claim 8, wherein hay bales queued on the prep table are progressed through the queue via actuation of a drive system comprised within the prep table.

10. The hay bale conversion system of claim 9, wherein the drive system comprises a drive chain, a sprocket pair and a motor mechanically coupled to the sprocket.

11. The hay bale conversion system of claim 10, further comprising a plurality of cross bars that are mechanically connected to the drive chain such that, when the drive chain is actuated by the motor and sprocket, a cross bar in contact with a hay bale queued on the prep table will cause the hay bale to advance through the queue and toward the converter table.

12. The hay bale conversion system of claim 9, wherein the drive system comprises a conveyor belt.

13. The hay bale conversion system of claim 1, further comprising a feed table operationally connected to the converter table and a hay baler, wherein un-baled hay resulting from a hay bale being thrashed by the primary thrasher assembly is deposited onto the feed table and advanced toward the hay baler.

14. The hay bale conversion system of claim 13, wherein un-baled hay deposited on the feed table is advanced toward the hay baler via actuation of a drive system comprised within the feed table.

15. The hay bale conversion system of claim 14, wherein the drive system comprises a drive chain, a sprocket pair and a motor mechanically coupled to the sprocket.

16. The hay bale conversion system of claim 15, further comprising a plurality of cross bars that are mechanically connected to the drive chain such that, when the drive chain is actuated by the motor and sprocket, a cross bar in contact with the un-baled hay will cause the un-baled hay bale to advance toward the baler.

17. The hay bale conversion system of claim 14, wherein the drive system comprises a conveyor belt.

18. The hay bale conversion system of claim 13, further comprising a secondary thrasher assembly mechanically coupled to the feed table, wherein the secondary thrasher assembly is operable to further thrash the un-baled hay.

19. The hay bale conversion system of claim 18, wherein the vertical position of the secondary thrasher assembly relative to the feed table is adjustable.

20. The hay bale conversion system of claim 18, wherein the secondary thrasher assembly is hydraulically controlled.
